(19) United States
(12) Patent Application Publication
(10) Pub. No.: US 2005/0138405 A1
(43) Pub. Date: Jun. 23, 2005

(54) Media transport cassette

(75) Inventor: Daniel F. White, Lilburn, GA (US)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 10/739,507

(22) Filed: Dec. 18, 2003

(51) Int. Cl. H04L 9/32

(52) U.S. Cl. 713/194

(57) ABSTRACT

A method of transporting bank notes between a cassette loading center and one of a plurality of automated teller machines (ATMs) is disclosed. The method utilizes a transport cassette for valuable media, comprising a sealable security housing for storing the media, a control processor and at least one display for displaying active information representative of the media within the cassette housing. The method comprises updating the cassette display each time a bank note is removed from the cassette housing.

The present application relates to a transport and storage cassette for valuable media and particularly, but not exclusively, to a cassette for the transport and storage of bank notes.

### BACKGROUND OF THE INVENTION

Various organizations have a need to transport valuable items of one kind or another between physically separated locations in a secure manner. Possibly the most common example of this requirement is the transfer of bank notes from a central or local storage point to one or more automated teller machines (ATM). The bank notes dispensed by an ATM are held in individual cassettes, each cassette containing bank notes of one particular value. Due to the popularity of ATMs they require frequent restocking of bank notes and therefore a relatively large amount of money is generally in transport between one or more banks and the number of ATMs. The secure transport of this money is naturally of great concern to banking organizations.

Typically, bank notes are transported in cassettes that themselves are to be fitted within the ATMs. Whilst the cassettes may include security features to prevent the cassettes themselves being forcibly opened to gain access to the bank notes, for example ink spoiling systems, there is still a possibility of unauthorized removal of notes from some cassettes during transit. Furthermore, the security systems generally known in the art still provide the opportunity for an incorrect cassette to be placed in an ATM. By “incorrect”, it is meant that, for example, a cassette containing bank notes of a first value or denomination are placed in a region of the ATM intended for bank notes of a second value or denomination. Additionally, it is common practice when loading the cassettes into an ATM for the total value of the bank notes held within a particular cassette to be entered by an operator into the ATM system, generally by keying in the value on a keypad. As well as providing a record of the value of bank notes deposited into an ATM, this allows the ATM system to deduce when notes to a predetermined value have been dispensed, for example to issue an alarm that notes of that value will soon be exhausted from the cassette. The opportunity therefore also exists for incorrect cassette content values to be keyed in.

In addition cassettes can be removed from an ATM, for replenishment, before they are completely emptied of notes. It is a further cash management problem to provide information on the quantity and denomination of notes within these cassettes, which will be sealed for security reasons.

### SUMMARY OF THE INVENTION

It is an object of the present invention to ameliorate one or more of the aforementioned problems.

According to a first aspect of the present invention there is provided a transport cassette for valuable media, comprising a sealable security housing for storing the media, a control processor and at least one display for displaying active information representative of the media within the cassette housing.

Preferably, the displayed information includes a unique cassette identification number.

Additionally, the displayed information includes the present quantity and/or denomination of notes within the cassette housing.

Most preferably, the display is updated when a note is removed from the cassette.

Preferably, the display is a human-readable display, and most preferably a bistatic display. Alternatively, the human-readable display is an LCD display.

Alternatively, the display is a machine-readable display, most preferably an RFID tag.

Preferably, each tag is arranged to transmit information to an ATM to which the cassette is coupled.

Additionally, each tag is arranged to transmit information to a control center.

Preferably, the control processor is a SMART card chip.

An advantage of the invention is the provision of low cost encryption security. A secure system is commercially critical to maintain the integrity of the system, and insure that the display accurately reflects the number of bank notes contained in the cassette.

According to a second aspect of the present invention there is provided a currency cassette transportation system, incorporating a control center, a plurality of automated teller machines (ATMs) and a plurality of transport cassettes for bank notes, each cassette comprising a sealable security housing for storing the bank notes, a control processor and at least one display for displaying active information representative of the media within the cassette housing, and means for transporting said cassettes, each cassette being arranged to communicate with the control center during transportation if a bank note is removed from the cassette prior to it docking with an ATM within the system.

According to a third aspect of the present invention there is provided a method of transporting bank notes between a cassette loading center and one of a plurality of automated teller machines (ATMs), utilizing a transport cassette for valuable media comprising a sealable security housing for storing the media, a control processor and at least one display for displaying active information representative of the media within the cassette housing, the method comprising updating the cassette display each time a bank note is removed from the cassette housing.

### BRIEF DESCRIPTION OF THE DRAWINGS

An embodiment of the present invention will now be described, by way of example, with reference to the accompanying drawings, in which:

FIG. 1 schematically illustrates a standard prior art ATM;

FIG. 2 schematically illustrates the internal components of the ATM;

FIG. 3 schematically illustrates a currency cassette in accordance with the present invention; and

FIG. 4 schematically illustrates a currency cassette transportation system in accordance with the present invention.

### DETAILED DESCRIPTION

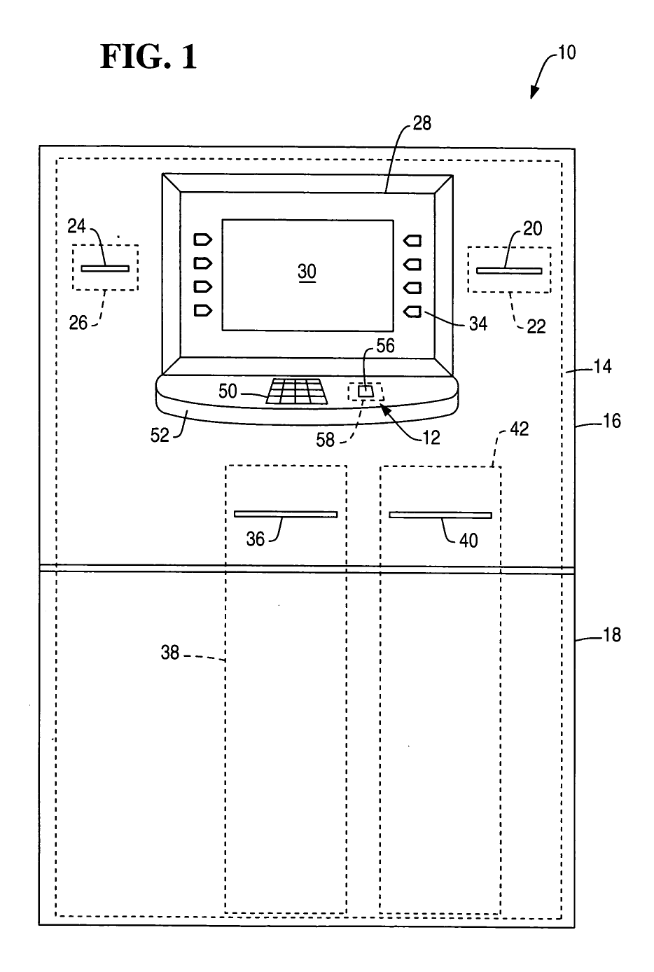

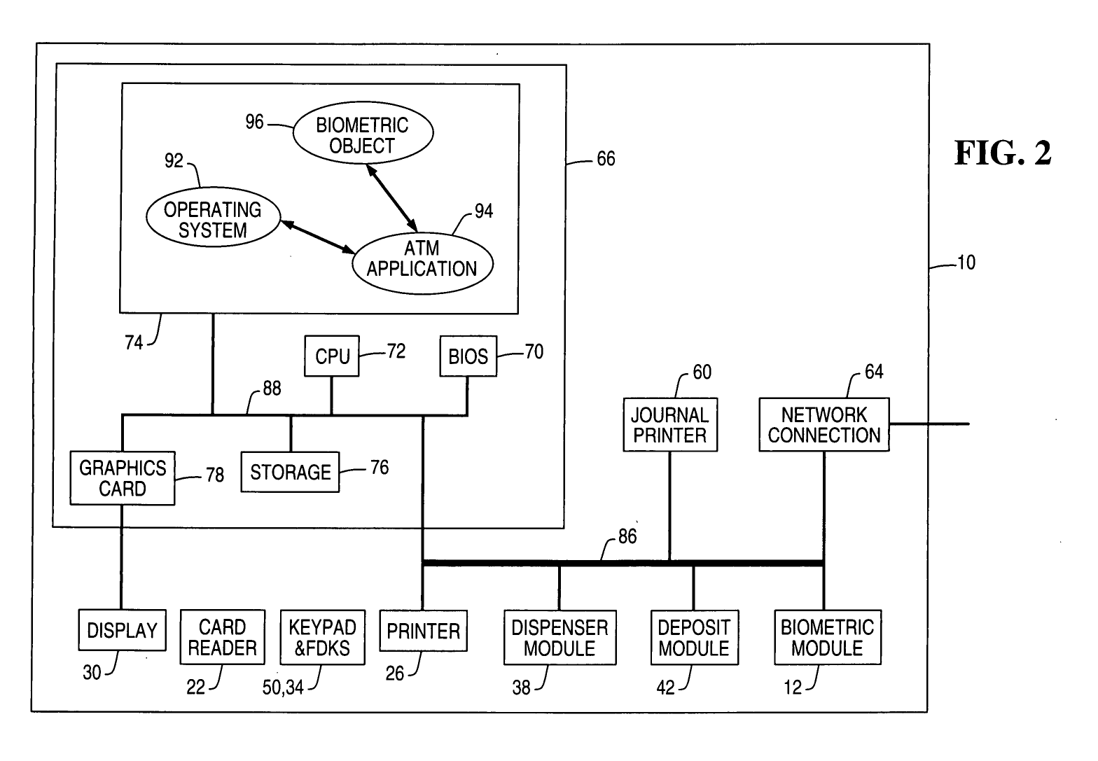

Prior to discussing the cassette and system in accordance with the present invention, we will briefly review the operation of an ATM, with which the cassettes are adapted to be used. Reference is now made to FIGS. 1 and 2, which show a self-service terminal 10 in the form of an automated teller machine (ATM). The ATM 10 has a chassis 14 to which is pivotably coupled a plastic fascia 16 covering an upper portion of the chassis 14. A door 18 is hingably coupled to a lower portion of the chassis 14. When the fascia 16 is hinged open and the door 18 is swung open, an operator can gain access to modules located within the ATM 10.

The fascia 16 provides a user interface to allow a user to interact with the ATM 10. In particular, the fascia 16 has apertures aligning with modules mounted in the chassis 14 when the fascia 16 is pivoted to the closed position. The fascia 16 defines the card reader slot 20 aligning with a card reader module 22 mounted within the chassis 14; a receipt printer slot 24 aligning with a receipt printer module 26 mounted within the chassis 14; a display aperture 28 aligning with a combined display 30 and associated function display keys (FDKs) 34 mounted as a module within the chassis 14; a dispenser slot 36 aligning with a dispenser module 38 mounted within the chassis 14; and a deposit aperture 40 aligning with a deposit module 42 mounted within the chassis 14.

The fascia 16 also includes an encrypting keypad 50 mounted on a shelf portion 52 extending outwardly from beneath the display aperture 28. The encrypting keypad 50 also receives input from the FDKs 34.

A biometric module 12 is mounted in the shelf portion 52 and includes (i.) a sensor 56 for receiving a human finger and for capturing fingerprint details, and (ii.) an interface 58 for encrypting and relaying a captured fingerprint image. The sensor 56 protrudes through an aperture in the shelf portion 52, and the interface 58 is mounted behind the shelf portion 52. The biometric sensor 56 is a Fingerloc (trade mark) AF-S2 fingerprint sensor, available from Authentec, Inc., P.O. Box 2719, Melbourne, Fla. 32902-2719, U.S.A.

As illustrated in FIG. 2, internally, the ATM 10 also includes a journal printer module 60 for creating a record of every transaction executed by the ATM 10, a network connection module 64 for accessing a remote authorization system (not shown), and a controller module 66 (in the form of a PC core) for controlling the operation of the ATM 10, including the operation of the modules.

The controller 66 comprises a BIOS 70 stored in non-volatile memory, a microprocessor 72, associated main memory 74, storage space 76 in the form of a magnetic disk drive, and a display controller 78 in the form of a graphics card.

The display module 30 is connected to the controller module 66 via the graphics card 78 installed in the controller module 66. The other ATM modules (12, 22, 26, 34, 38, 42, and 50) are connected to the ATM controller 66 via a device bus 86 and one or more internal controller buses 88.

The dispenser module 38 contains means (not shown) for receiving currency cassettes, each of which contain a specific denomination of bank note. A pick unit is also provided to pick notes from each of the cassettes and transport them to a dispenser slot 36, for collection by a user.

In use, the main memory 74 is loaded with an ATM operating system kernel 92, an ATM application 94, and a biometric capture object 96. As is well known in the art, the operating system kernel 92 is responsible for memory, process, task, and disk management. The ATM application 94 is responsible for controlling the operation of the ATM 10. In particular, the ATM application 94 provides the sequence of screens used in each transaction (referred to as the transaction flow); monitors the condition of each module within the ATM (state of health monitoring); and obtains authorization for transactions from a remote transaction authorization server (not shown).

The term “screen” is used herein to denote the graphics, text, controls (such as menu options), and such like, that are presented on an self service terminal (SST) display; the term “screen” as used herein does not refer to the hardware (that is, the display) that presents the graphics, text, controls, and such like. Typically, when a transaction is being entered at an SST, a series of screens are presented in succession on the SST display, the next screen displayed being dependent on a user entry or activity relating to the current screen. For example, a first screen may request a user to insert a card; once a card has been inserted a second screen may invite the user to enter his/her PIN; once the final digit of the PIN has been entered, a third screen may invite the user to select a transaction; and so on.

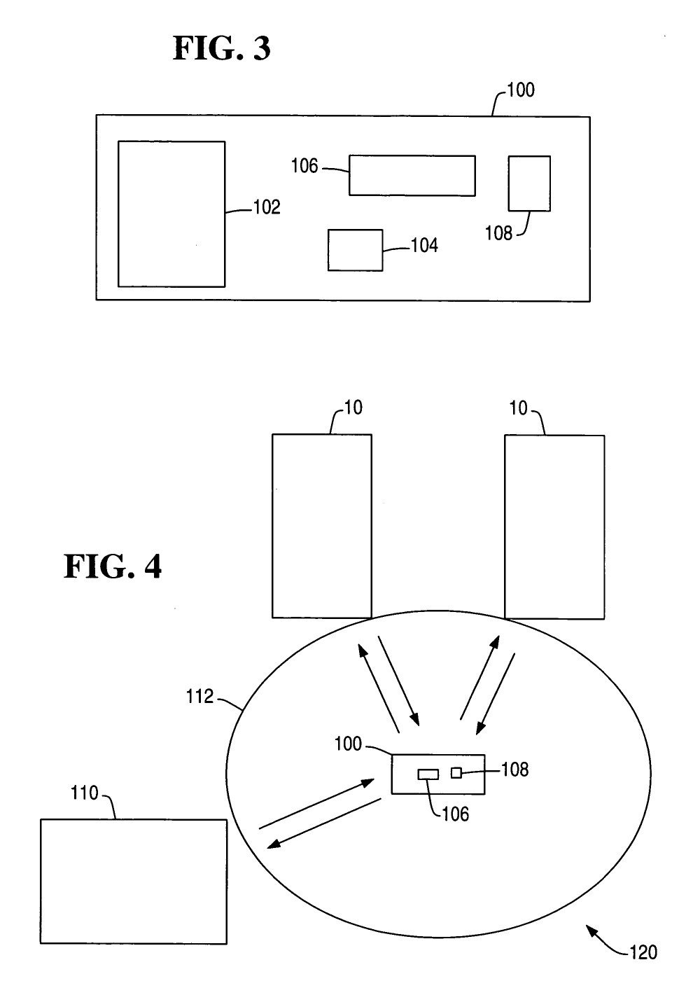

FIG. 3 illustrates a transport cassette 100 in accordance with the present invention. The transport cassette 100 comprises a sealable security housing 102 for storing the media to be transported. The cassette also contains a control processor 104, in the form of a SMART card chip and, at least, one display 106, 108 for displaying active information representative of the media within the cassette housing. The display can be either a human-readable display 106, such as a bistatic display or an LCD display, or a machine-readable display 108 or both. If an LCD display is utilized a battery (not shown) may also be included so that the display can operate when the cassette 100 is not coupled to an ATM 10.

The information includes a unique cassette identification number, so that a plurality of such cassettes 100 can be utilized within a transport system 120 (FIG. 4), as described below. Additionally, the information includes the present quantity and denomination of bank notes within the cassette housing 102. The control processor 104 updates the display 106, 108 when a note is removed from the cassette 100.

The machine-readable display 108 is an RFID tag, which is arranged to transmit information to an ATM 10 when coupled thereto. Also tag 108 is arranged to transmit information to a control center 110, via a communications network 112.

The currency cassette transportation system 120 incorporates a control center 110, a plurality of automated teller machines (ATMs) 10 and a plurality of transport cassettes 100 as described above, each cassette being arranged to communicate with the control center 110 during transportation if a bank note is removed from a the cassette 100 prior to it docking with an ATM 10 within the system.

When in use, bank notes are transported between a cassette loading center, which may be co-located with the control center 110, and one of a plurality of automated teller machines (ATMs) 10. A transport cassette 100, as described above is utilized. The cassette is collected and transported in a secure vehicle (not shown) as normal. Unauthorized removal of notes from the cassette 10 is discouraged because the visible display 106 is altered in real time to indicate to the security staff transporting the cassette 10 that a note has been removed. (If the cassette in not in the ATM, then the display could show a tamper or error symbol if the cassette is opened, but the processor would not know how many bank notes were removed.) In addition if the cassette is in transit the control center 110 is informed, either directly or alternatively via a nearby ATM 10. Once the cassette is coupled to an ATM the information from the display 106, 108 is transmitted via the ATM communications system.

In addition, the visible display 106 make it easier for staff to ensure that a cassette 10 is located at the correct place for cassettes containing the denomination of bank notes in question, when replenishing the ATM 10.

The term display is intended to mean a human-readable display or a machine-readable display such as an RFID tag. Such a tag although it does not display information visibly can transmit information.

The foregoing description of the preferred embodiment of the invention has been presented for the purposes of illustration and description. It is not intended to be exhaustive or to limit the invention to the precise form disclosed. Many modifications and variations are possible in light of the above teaching within the spirit and scope of the invention as claimed.

1. A transport cassette for valuable media, comprising a sealable security housing for storing the media, a control processor and at least one display for displaying active information representative of the media within the cassette housing.

2. The cassette according to claim 1, wherein the displayed information includes a unique cassette identification number.

3. The cassette according to claim 1, wherein the displayed information includes the present quantity of notes within the cassette housing.

4. The cassette according to claim 1, wherein the displayed information includes the denomination of the notes within the cassette housing.

5. The cassette according to claim 3, wherein the display is updated when a note is removed from the cassette.

6. The cassette according to claim 1, wherein the display is a human-readable display.

7. The cassette according to claim 6, wherein the display is a bistatic display.

8. The cassette according to claim 6, wherein the display is an LCD display.

9. The cassette according to claim 1, wherein the display is a machine-readable display.

10. The cassette according to claim 9, wherein the display is an RFID tag.

11. The cassette according to claim 10, wherein each tag is arranged to transmit information to an ATM to which the cassette is coupled.

12. The cassette according to claim 10, wherein each tag is arranged to transmit information to a control center.

13. The cassette according to claim 1, wherein the control processor is a SMART card chip.

14. A currency cassette transportation system, incorporating a control center, a plurality of automated teller machines (ATMs) and a plurality of transport cassettes for bank notes, each cassette comprising a sealable security housing for storing the bank notes, a control processor and at least one display for displaying active information representative of the media within the cassette housing, and means for transporting said cassettes, each cassette being arranged to communicate with the control center during transportation if a bank note is removed from a the cassette prior to it docking with an ATM within the system.

15. The system according to claim 14, wherein the displayed information includes a unique cassette identification number.

16. The system according to claim 14, wherein the displayed information includes the present quantity and denomination of notes within the cassette housing.

17. The system according to claim 14, wherein the display is updated when a note is removed from the cassette.

18. The system according to claim 14, wherein the display is a human-readable display.

19. The system according to claim 14, wherein the display is a machine-readable display.

20. The system according to claim 19, wherein the display is an RFID tag.

21. The system according to claim 20, wherein each tag is arranged to transmit information to an ATM to which the cassette is coupled.

22. The system according to claim 20, wherein each tag is arranged to transmit information to the control center.

23. The system according to claim 14, wherein the cassette transmits information to the control center periodically regardless of whether or not a bank note has been removed from the cassette housing.

24. A method of transporting bank notes between a cassette loading center and one of a plurality of automated teller machines (ATMs), utilizing a transport cassette for valuable media comprising a sealable security housing for storing the media, a control processor and at least one display for displaying active information representative of the media within the cassette housing, the method comprising updating the cassette display each time a bank note is removed from the cassette housing.

25. The method according to claim 24, wherein the cassette is in communication with a control center, to transmit said active information to the control center.

26. The method according to claim 25, wherein the active information includes a unique cassette identification number.

27. The method according to claim 25, wherein the active information includes the present quantity and denomination of notes within the cassette housing.

28. The method according to claim 25, wherein information is transmitted to the control center each time a bank note is removed from the cassette housing in transit.

29. The method according to claim 25, wherein information is transmitted to an ATM once the cassette is coupled to said ATM.

30. The method according to claim 24, wherein the information is displayed in human-readable form on a display on the cassette and is updated each time a bank note is removed from the cassette.
